(19) United States
(12) Patent Application Publication
(10) Pub. No.: US 2011/0184794 A1
(43) Pub. Date: Jul. 28, 2011

(54) REFERRAL INCENTIVE SYSTEM AND METHOD

(75) Inventor: Jason Friedland, Yonkers, NY (US)

(73) Assignee: Shleppers Holding LLC, Yonkers, NY (US)

(21) Appl. No.: 12/694,553

(22) Filed: Jan. 27, 2010

(51) Int. Cl. G06Q 30/00; G06Q 50/00; G06Q 10/00

(52) U.S. Cl. 705/14.16; 705/30

(57) ABSTRACT

A system and method for providing referral based incentive awards for a moving company. The system includes storage means for electronically storing a plurality of client referral records. Each of the plurality of client referral records preferably includes a plurality of metadata fields identifying a referring client's name, a referred customer's name and information relating to a status of the move task associated with the referred customer's name. The system further includes processor means coupled to the storage means for processing each of the client referral records to determine if an incentive award is due a referring client. An incentive award may be due based at least upon a change in status of a move task in the metadata associated with a referred customer's name.

### FIELD OF THE INVENTION

The invention pertains to a system and data processing techniques useful in service industries. More particularly this invention pertains to a system and data processing techniques for managing the different referral relationships that a service industry company has with its customers and providing a customer incentive system.

### BACKGROUND OF THE INVENTION

There is a recognized need in the services industry to attract and retain loyal referring clients. A loyal referring client is one who establishes all or a significant number of his relationships with their respective clients/customers with a single service provider for a particular task (e.g., the moving industry) and does so over an extended period of time. This need is particularly important to service industry companies in medium and large sized communities where there is aggressive competition with regionally and nationally marketed similar service industry companies which are attracting clients away from the local institutions. This need is also important to service companies in the moving industry situated in highly competitive markets where potential customers are offered a wide variety of options and pricing plans by other companies in the moving industry, some of which may individually be very enticing to potential customers, whether realistic or not.

Incentive programs for rewarding repeat or ongoing referring clients have become increasingly common in a variety of industries. Well known examples of the use of incentives to attract and reward repeated customer patronage are airline frequent flyer programs. In airline frequent flyer programs the customer is awarded points, often expressed in terms of “miles traveled” for each use of a particular airline or its affiliates. Additional points or “miles” are awarded for use of ancillary services such car and hotel room rentals.

While many companies (including banks, airline, credit card companies, grocery stores, etc.) have incentive programs for their clients/customers, there currently is no such known incentive program in the moving industry. This is because the implementation of a client incentive program for a moving company has complexities not found in customer incentive plans in other industries. The relationships between a moving company and any one of its clients, or potential clients, who may provide a customer referral are quite numerous and complex, involving a number of different industries including real estate brokers, building managers, doorman, etc. Most other incentive programs require tracking of only one customer factor such as miles traveled in a frequent flyer program or the total dollar volume of purchases in a grocery store trading stamp program which can easily be performed on an automated basis. However, in the moving industry, no such automated commonality of its referring clients/customers past activities exist. The tracking of its referring clients/customers is difficult, time consuming and labor intensive. Thus, establishing and managing an incentive program for its referring clients/customers is likewise difficult, time consuming and labor intensive.

Furthermore, for an incentive program to be fully effective as a tool for attracting and retaining long-term referring clients, it is desirable for the moving company's management to be able to monitor the relationships between the moving company and its referring clients as individuals and in groups. The moving company may thus be able to identify significant opportunities for marketing its moving services by evaluating the relationships and their appeal to potential customers.

It is against this background that the present invention has evolved.

### SUMMARY OF THE INVENTION

The invention generally relates to the marketing, monitoring and administration of a referral program for generating new business opportunities based on incentives.

In one aspect, a system and method is described in which an aspect of the invention includes providing referral based incentive awards for a moving company. The system includes storage means for electronically storing a plurality of client referral records. Each of the plurality of client referral records preferably includes a plurality of metadata fields identifying a referring client's name, a referred customer's name and information relating to a status of the move task associated with the referred customer's name. The system further includes processor means coupled to the storage means for processing each of the client referral records to determine if an incentive award is due a referring client. An incentive award may be due based at least upon a change in status of a move task in the metadata associated with a referred customer's name.

In further, optional aspects, the invention includes a computer program product consisting of a computer useable medium having a computer readable program code embodied therein. The computer readable program code is adapted to be executed to implement a method for providing referral based incentive awards for a moving company. The method includes the steps of storing a plurality of client referral records in storage means. Each of the plurality of client referral records has a plurality of metadata fields identifying a referring clients name, a referred customers name and information relating to a status of the move task associated with the referred customer's name. The method further includes the step of processing each of the client referral records in a processor to determine if an incentive award is due a referring client based at least upon a change in status of a move task associated with a referred customers name.

It is to be appreciated that an embodiment of the invention can implement one or more of these optional aspects. Providing a customer move type metadata field in each of the plurality of client referral records to determine an amount for an incentive award when an incentive award is determined due a said referring client. Providing a customer move geography field in each of the plurality of client referral records to further determine an amount for an incentive award. Providing a customer move price metadata field in each of the plurality of client referral records to further determine an amount for an incentive award. And providing a customer commission terms metadata field in each of the plurality of client referral records to determine a payment format for an incentive award.

### BRIEF DESCRIPTION OF THE DRAWINGS

The objects and features of the invention can be understood with reference to the following detailed description of certain embodiments of the invention taken together in conjunction with the accompanying drawings in which:

FIG. 1 is a block diagram of a computer system that can be used with certain embodiments of the invention;

FIGS. 2-3 are system level diagrams illustrating components for executing the method of certain embodiments of the invention;

FIG. 4 depicts a client referral record used by the system of FIGS. 2 and 3 for implementing and tracking client commissions;

FIG. 5 depicts an award record used by the system of FIGS. 2 and 3 for determining a client commission fee;

FIG. 6 is a flow chart illustrating steps taken by the system of FIGS. 2 and 3 for initiating client commission awards; and

FIG. 7 is an exemplary record generated by the system of FIGS. 2 and 3 for tracking client commission award payments based upon selected metadata.

### WRITTEN DESCRIPTION OF CERTAIN EMBODIMENTS OF THE INVENTION

The present invention is now described more fully with reference to the accompanying drawings, in which an illustrated embodiment of the invention is shown. The invention is not limited in any way to the illustrated embodiment as the illustrated embodiment described below is merely exemplary of the invention, which can be embodied in various forms, as appreciated by one skilled in the art. Therefore, it is to be understood that any structural and functional details disclosed herein are not to be interpreted as limiting the invention, but rather are provided as a representative embodiment for teaching one skilled in the art one or more ways to implement the invention. Furthermore, the terms and phrases used herein are not intended to be limiting, but rather are to provide an understandable description of the invention. Additionally like reference numerals are to be understood to refer to like elements.

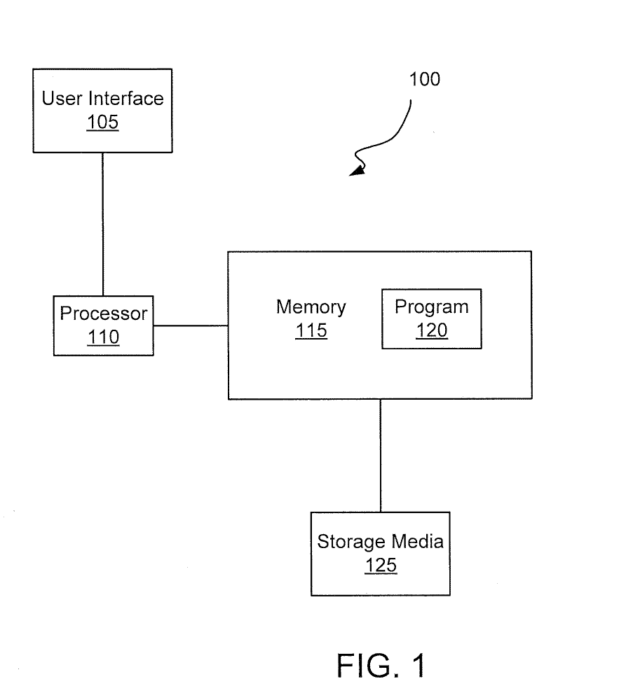

It is to be appreciated that the embodiments of this invention as discussed below may be incorporated as a software algorithm, program or code residing in firmware and/or on computer useable medium (including software modules and browser plug-ins) having control logic for enabling execution on a computer system having a computer processor. Such a computer system typically includes memory storage configured to provide output from execution of the computer algorithm or program. An exemplary computer system is shown as a block diagram in FIG. 1 depicting computer system 100. Although system 100 is represented herein as a standalone system, it is not limited to such, but instead can be coupled to other computer systems via a network (not shown) or encompass other embodiments as mentioned below. System 100 preferably includes a user interface 105, a processor 110 (such as a digital data processor), and a memory 115. Memory 115 is a memory for storing data and instructions suitable for controlling the operation of processor 110. An implementation of memory 115 can include a random access memory (RAM), a hard drive and a read only memory (ROM), or any of these components. One of the components stored in memory 115 is a program 120.

Program 120 includes instructions for controlling processor 110. Program 120 may be implemented as a single module or as a plurality of modules that operate in cooperation with one another. Program 120 is contemplated as representing a software embodiment of the method 600 described hereinbelow and for recording and processing the below described information.

User interface 105 can include an input device, such as a keyboard, touch screen, tablet, API web services interface or speech recognition subsystem, for enabling a user to communicate information and command selections to processor 110. User interface 105 also includes an output device such as a display or a printer. In the case of a touch screen, the input and output functions are provided by the same structure. A cursor control such as a mouse, track-ball, or joy stick, allows the user to manipulate a cursor on the display for communicating additional information and command selections to processor 110. In embodiments of the present invention, the program 120 can execute entirely without user input or other commands based on programmatic or automated access to a data signal flow through other systems that may or may not require a user interface for other reasons.

While program 120 is indicated as already loaded into memory 115, it may be configured on a storage media 125 for subsequent loading into memory 115. Storage media 125 can be any conventional storage media such as a magnetic tape, an optical storage media, a compact disc, or a floppy disc. Alternatively, storage media 125 can be a random access memory, or other type of electronic storage, located on a remote storage system, such as a server that delivers the program 120 for installation and launch on a user device.

It is to be understood that the invention is not to be limited to such a computer system 100 as depicted in FIG. 1 but rather may be implemented on a general purpose microcomputer incorporating certain components of system 100, such as one of the members of the Sun® Microsystems family of computer systems, one of the members of the IBM® Personal Computer family, one of the members of the Apple® Computer family, or a myriad of other computer processor driven systems, including a: workstations, desktop computers, laptop computers, netbook computers, a personal digital assistant (PDA), or a smart phone or other like handheld devices.

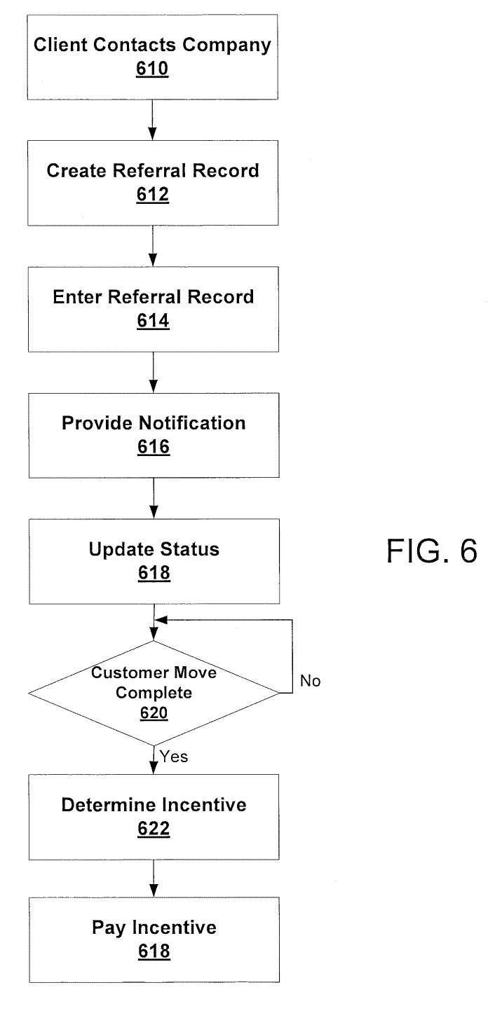

The method 600 described herein has been indicated in connection with a flow diagram (FIG. 6) for facilitating a description of the principal processes of an illustrated embodiment of the invention; however, certain blocks can be invoked in an arbitrary order, such as when the events drive the program flow such as in an object-oriented program. Accordingly, the flow diagram is to be understood as an example flow and that the blocks can be invoked in a different order than as illustrated.

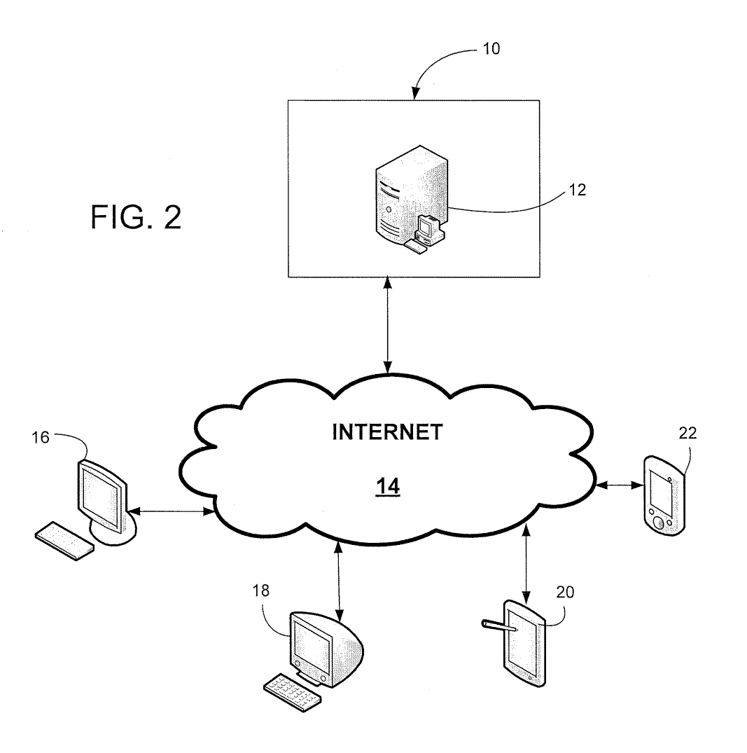

Referring now to FIG. 2, the basic components of a system for providing a referral incentive program, designated generally by reference numeral 10, and consistent with the present invention in accordance with certain embodiments, is shown. System 10 includes a data processing system 12 coupled to the Internet 14 so as to couple with numerous internet connected client devices 16-22. It is to be appreciated that client devices 16-22 may consist of standalone devices such a computer workstations (16, 18) or handheld devices (20, 22), such as PDA devices, smart phone devices (e.g., BLACKBERRY™, IPHONE™, PALM PRE™, ANDROID™ OS driven devices and the like). It is to be further appreciated that each of system 10 and client devices 16-22 preferably incorporate components of the aforesaid system 100 described above with reference to FIG. 1.

It is to be appreciated that while the below described invention for providing a incentive system for referrals is to be understood to be applicability to virtually any company or service oriented company in which referral of new business opportunities is a valuable commodity, for description and demonstrative purposes, the below described invention will be described in reference for use with a moving company (“company”). Also, a “client” is to refer to a party who refers an new business opportunity to the company, which business opportunity is referred to as a “customer.”

It is further to be appreciated that while system 10 is shown coupled to client devices 16-22, via the Internet 14, information from clients as described below may alternatively be input to system 10 through known conventional means. An example of such is a client communicating with an operator of system 10 who inputs appropriate client information into system 10. It is also to be understood that each of client devices 16-22 interface with system 10 via a web browser interface hosted by system 10. Alternatively, each of client devices 16-22 may be provided with an application programmed to directly interface with, and input information, from the client device 16-22 to the system 10, via the Internet 14. For instance, client device 22 may be an IPHONE™ device in which a client downloads and installs an IPHONE™ application onto it enabling a client to simply start the IPHONE™ application so as to access and input information directly to system 10 without the need to use a web browser, the advantages of which will become apparent below.

In yet another embodiment for inputting client referral information into system 10, the company may conduct a direct marketing campaign to specific client user types (e.g. broker, doorman, etc.) (as further discussed below). Each marketing campaign will instruct the targeted client, of a specific user category type, to access the company's website at a URL specific to that client category type. For example, the company may conduct a direct marketing campaign to doorman user types instructing such doormen to access the company's referral website at a URL unique to doorman (e.g., http://www.movingcompany.com/referral/doorman@3). Additionally, the company may conduct a direct marketing campaign to a building employee user type instructing such building employees to access the company's referral website at a URL unique to building employees (e.g., http://www.movingcompany.com/referral/buildinqemployee@7). Thus, based upon the URL used by the client to create a client record 40, system 10 automatically recognizes the client user type (the significance of which will become apparent below) when creating the client record 40. Also, administrators of system 10 can gauge the success of a particular marketing campaign directed to a particular client user type based on the aforesaid access to the URL's unique to each client user type.

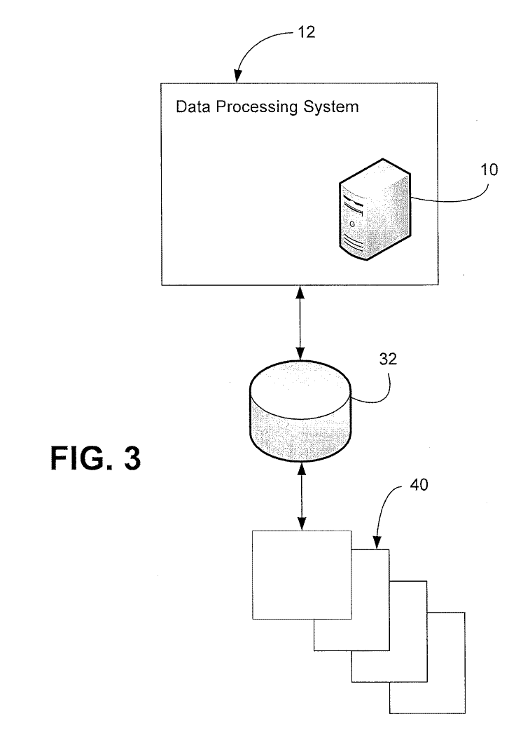

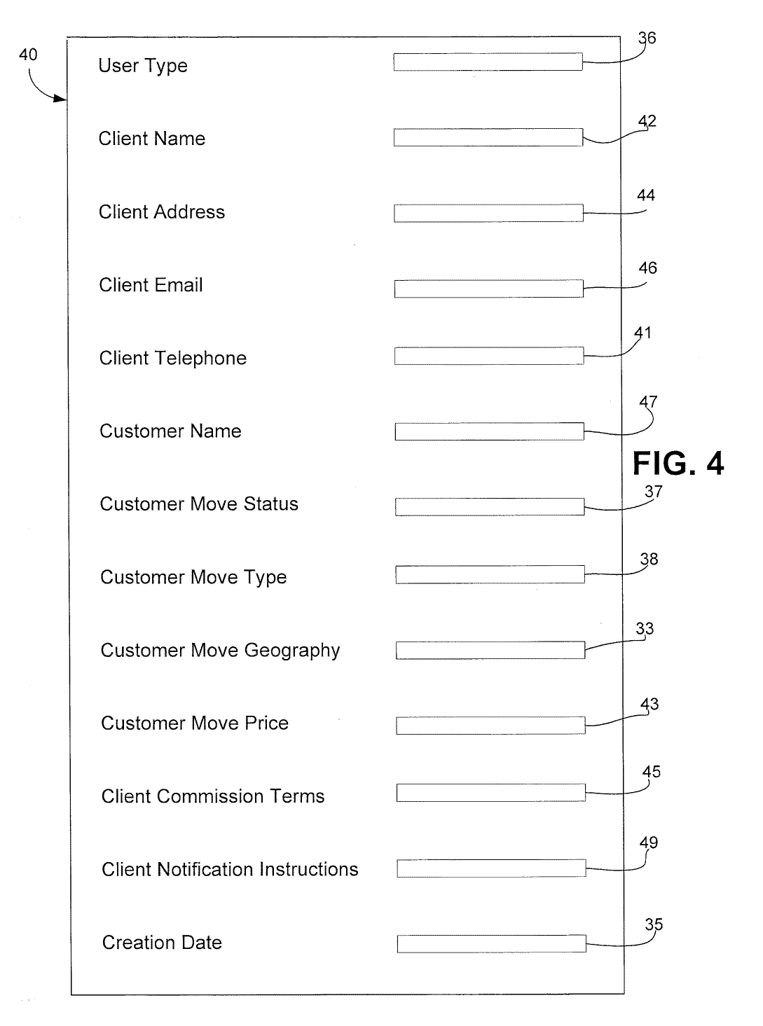

With reference now to FIG. 3, system 10 includes a database 30 having memory storage means 32 for storing a plurality of client records 40 (FIG. 4) relating to information pertaining to aforesaid clients and customers, as discussed further below. It is to be appreciated the aforesaid client records 40 of database 30 are managed by system 10 to ensure the information in the records 40 are complete and updated when appropriate. It is to be further appreciated each below described metadata field of each client record 40 is searchable by system 10, the significance of which will also become apparent below.

FIG. 4 depicts the information input to system 10 relating to each customer referral from a client, as reflected in a client record 40. This information is input into database 30 of system 10 via either a client device 16-22, an administrator of system 12, or a hybrid of a client device 16-22 and a system administrator. As described below, each client record 40 preferably includes the following metadata fields:
User Type (36) category;
Client name (42);
Client address information (44);
Client email contact information (46);
Client telephone information (41);
Customer name (47)
Customer move status (37);
Customer move type category (38);
Customer move geography category (33);
Customer move price (43);
Client commission payment terms (45); and
Notification instructions (49).

Each of the above mentioned metadata fields contained in a client record 40 will now be discussed:
The User Type (36) field is the category given for the client preferably selected from the group consisting of: company administrator, real estate broker, building employee, company employee, langsman, manager and referrer.
Client Name (42) is the name of the referring client who is recommending a Customer (47) to the moving company.
Client Address (44) is the contact address for the Client (42).
Client Email (46) is the contact Email address for the Client (42).
Client Telephone (41) contains the telephone numbers (e.g., work, home, cell) for the Client (42).
Customer Name (47) is the name of the customer referred to the moving company by the Client (42).
Customer Move Status (37) indicates the current status of the move task associated with the Customer (47) preferably selected from the group consisting of: completed, booked, not applicable, lost and deleted.
Customer Move Type (38) indicates whether the Customer's (47) move task is a residential or commercial move.
Customer Move Geography (33) indicates whether the Customer's (47) move task is a local or long distance move.
Customer's Move Price (43) refers to the price of a Customer's (47) move, from which the Client's (42) commission is contingent upon.
Client Commission Terms (45) refers to the manner in which the Client (42) desires to have their owed commission paid to them, preferably selected from the group consisting of:
   (1) the commission fee sent to the Client's Address (44);
   (2) the commission fee sent to a prescribed business associate of the Client (42);
   (3) the commission fee sent to the Customer (47) to whom the Client (42) referred; or
   (4) a charity (preferably in the form of a donation) selected by the Client.
Client Notification Instructions (49) refers to whether a Client (42) desires notification to a party in the moving company indicating that the Client (42) has made a referral.
Creation Date (35) indicates the date the Client (42) made the Customer (47) referral.

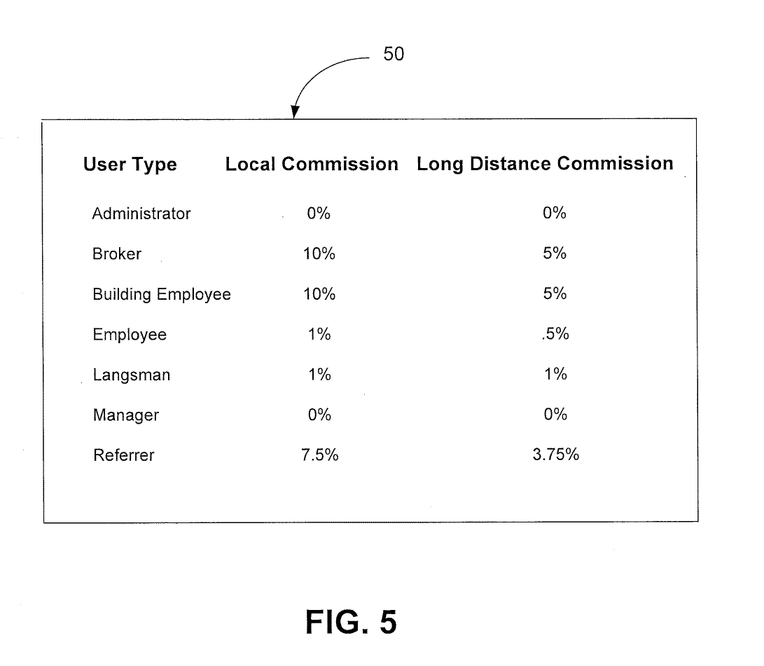

With reference now to FIG. 5, shown is a referral fee record 50, preferably used by system 12 for determining the commission fee to be awarded to a Client (42) when a Customer (47) (referred by the Client (42) to the moving company) completes a moving task. As depicted, the commission fee is contingent upon the given User Type (36) for the Client (42) and the Customer Move Geography (33). For instance, a Client (42) of a User Type (36) who qualifies as a “Broker” and refers a Customer (47) who completes a Customer Move Geography (33) qualifying as a “local” move is entitled to a 10% commission fee. While a Client (42) of a User Type (36) who qualifies as a “Building Employee” (e.g., a doorman) and refers a Customer (47) who completes a Customer Move Geography (33) qualifying as a long distance geography move is entitled to a 5% commission fee. It is to be appreciated the metadata parameters of this referral fee record, preferably used by system 12, can be adjusted by an administrator of system 12 when desired.

With the basic components of the incentive referral system 12 described above, its method of operation in accordance with certain embodiments will now be discussed with reference to the method designated generally by reference numeral 600 in FIG. 6.

Starting at step 610, a Client (42) contacts the company to provide a Customer (47) referral. As mentioned above, a Client (42) contacts the company to provide a Customer (47) referral via a website interface, a customized software application executing on a client device 16-22 via the Internet 14, or via other traditional communicative means such as email and telephony. A client referral record 40 is then created by information provided by a Client (42) (step 612) to system 10. It is noted the client referral record 40 may be automatically created by software via system 10 wherein the Client (42) provides such information through means such as an aforesaid company website interface programmed to capture such information or a customized software application executing on a client device 16-22. Alternatively, an administrator of system 10 creates a client referral record 40 to be preferably stored in the database 30 of system 10 (step 612) though information received through other communicative means. The information to be included in the client referral record 40 has been mentioned above with reference to FIG. 4, which is incorporated herein.

Once the client referral record (40) has been created, it is then preferably stored in database 30 for processing thereof by system 10 (step 614). Upon entry into the database 30, system 10 determines if the Client (42) desires to provide notification (49) to preferably targeted personnel in the company indicating the Client (42) has provided a Customer (47) referral to company (step 616). If yes, then system 10 provides such a notification to the targeted recipient.

Once a client referral record (40) is entered in the database 30 of system 10, it is preferably updated by system 10 when there has been a change in the Move Status field (37) regarding the Customer's (47) move (step 618). For instance, when a Customer's (47) move has been completed, an administrator of system 10 updates Move Status field (37) in the relevant client record 40 to reflect this change of event.

It is to be appreciated, system 10 is preferably programmed to periodically monitor at least the aforesaid Move Status field (37) for each active stored client referral record 40 to determine if a commission fee is due a Client (42) (step 620). Preferably, this is contingent upon if the Move Status field (37) has matured to a “completed” status meaning the Customer's (47) move has been completed. If a commission fee is due a Client (42), then system 10 determines the chosen Commission Terms (45) and amount (FIG. 5) due the Client (42) (step 622). As mentioned above with reference to FIG. 5, the amount of the commission fee is contingent upon the “User Type” classification (36) of the Client (42) and the Customer Move Type (38). As also mentioned above, the payout of the commission fee is based upon the prescribed Client Commission Terms (45) as selected by the Client (42). Once the aforesaid incentive type and amount has been determined, system 10 is preferably operable to award such payment (step 624).

It is to be appreciated the aforesaid process depicted in FIG. 6 is preferably repeated for each client referral record 40 created and monitored by system 10 to determine a commission payment.

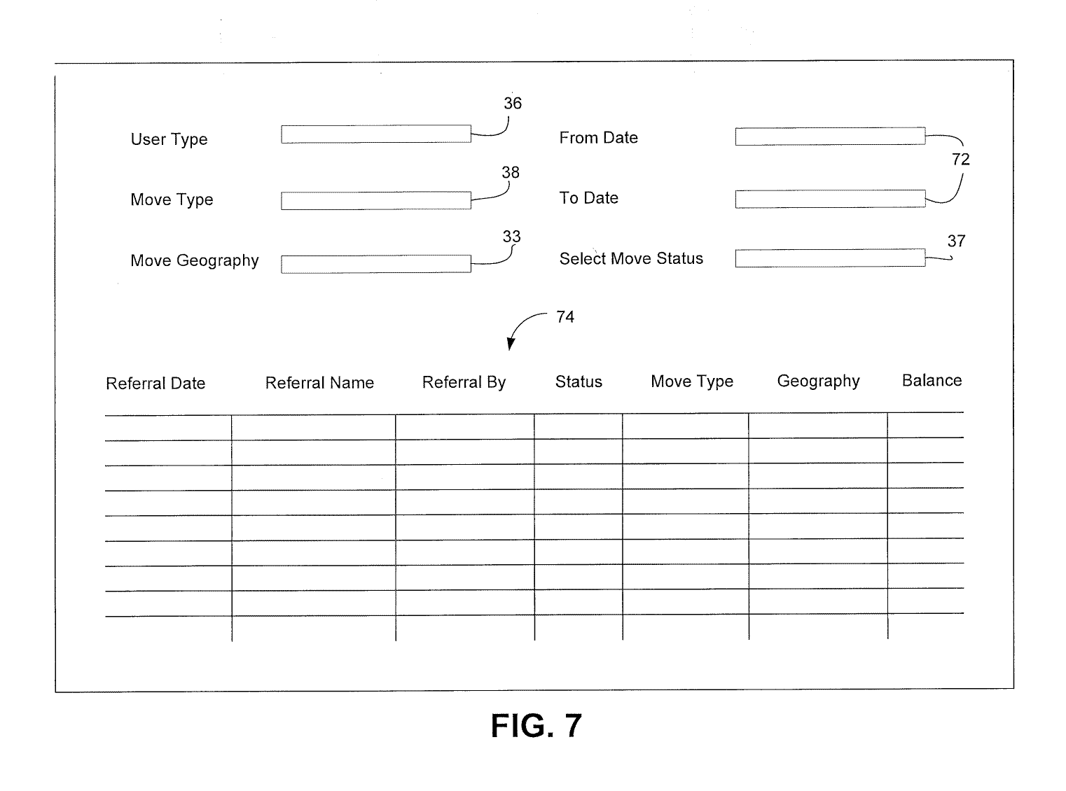

As mentioned above, the above described invention in accordance with at least the above illustrated embodiments, provides a method and system which accurately records, tracks and provides commission/incentive awards for customer referrals. In addition to providing a tool that creates new business opportunities through a referral process, data is captured by system 10 enabling the company to analysis the captured information to conduct targeted marketing efforts. For instance, and with reference to FIG. 7, an administrator of system 10 can readily generate a report detailing referrals based upon a number of searching metadata parameters including:
User Type (36)
Move Type (38)
Move Geography (33)
Referral Date Range (72)
Move Status (37)

Once the searching parameters have been selected, system 10 generates a report 74 pursuant to the selected searching parameters. This report may be used by the company to evaluate future business opportunities based on archived information relating to referring Clients (42).

Another key advantage of the invention is a ledger report that may be generated by various different clients (e.g., user type (36)) of system 10 indicating a status report for their respective referrals. For instance, a user type (36) of a doorman category may access system 10 (preferably via the Internet 14) to generate a ledger report indicating the names of the customers referred to the company by the doorman user type (36) indicating: the status (37) of the move associated with a customer; the customer move price (43); any owed commissions; any commission payments made and any commission balance due the doorman user type (36). In yet another example, a ledger report for a company employee, such as a salesperson, may be generated by system 10 identifying information relative to the clients recruited by such a salesperson for the company. This ledger report would also identify the move status and commission based information for each aforesaid client recruited by a company salesperson (as mentioned above with respect to a doorman user type). The ledger report would additionally identify commission based information owed to the aforesaid company salesperson based on the aforesaid activities for their recruited clients. Thus, the cacophony and informality typical of the common, non-systems based referral programs, is replaced with accurate documentation to monitor, administer and motivate those individuals who are generating referral business.

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although illustrated embodiments of the present invention has been described, it should be understood that various changes, substitutions, and alterations can be made by one of ordinary skill in the art without departing from the scope of the present invention.

What is claimed is:

1. A computer system for administrating referral based incentive awards for a moving company, the system comprising:
storage means for electronically storing a plurality of client referral records, each of the plurality of client referral records having a plurality of metadata fields identifying a referring clients name, a referred customers name and information relating to a status of the move task associated with the referred customer's name; and
processor means coupled to the storage means for processing each of said client referral records to determine if an incentive award is due a said referring client based at least upon a change in status of a said move task in said metadata associated with a said referred customer's name.

2. A computer system for administrating referral based incentive awards as recited in claim 1 further including a web site interface configured to capture said metadata information from Internet users for storing a client referral record in said storage means when an Internet user client becomes aware of a moving task opportunity for said moving company.

3. A computer system for administrating referral based incentive awards as recited in claim 1 further including a software application for coupling said computer system with remote Internet coupled user devices wherein a client using a said remote Internet coupled user device can capture said metadata information for creating a client referral record in said storage means when said client becomes aware of a moving task opportunity for said moving company.

4. A computer system for administrating referral based incentive awards as recited in claim 3 wherein said Internet coupled user device is a smart phone device.

5. A computer system for administrating referral based incentive awards as recited in claim 1 wherein each of said client referral records further includes a customer move type metadata field used by said processor means to determine an amount for an incentive award when a said incentive award is determined due a said referring client.

6. A computer system for administrating referral based incentive awards as recited in claim 5 wherein each of said client referral records further includes a customer move geography metadata field used by said processor means to determine an amount for an incentive award when a said incentive award is determined due a said referring client.

7. A computer system for administrating referral based incentive awards as recited in claim 6 wherein each of said client referral records further includes a customer move price metadata field used by said processor means to determine an amount for an incentive award when a said incentive award is determined due a said referring client.

8. A computer system for administrating referral based incentive awards as recited in claim 1 wherein each of said client referral records further includes a customer commission terms metadata field used by said processor means to determine a payment format for an incentive award when a said incentive award is determined due a said referring client.

9. A computer system for administrating referral based incentive awards as recited in claim 8 wherein said payment format is a payment to said client.

10. A computer system for administrating referral based incentive awards as recited in claim 8 wherein said payment format is a payment to said customer.

11. A computer system for administrating referral based incentive awards as recited in claim 8 wherein said payment format is a payment to a charity.

12. A computer system for administrating referral based incentive awards as recited in claim 1 wherein said processor means is programmed to generate a report from said client referral records based on user selected metadata fields relating to said client records.

13. A method for providing referral based incentive awards for a moving company using a computer system having storage and processor means, the method comprising the steps of:
storing a plurality of client referral records in said storage means, each of the plurality of client referral records having a plurality of metadata fields identifying a referring clients name, a referred customers name and information relating to a status of the move task associated with the referred customer's name; and
processing each of said client referral records in said processor means to determine if an incentive award is due a said referring client based at least upon a change in status of a said move task associated with a said referred customers name.

14. A method for providing referral based incentive awards as recited in claim 13 further including the step of providing a customer move type metadata field in each of the plurality of client referral records to be used by said processor means to determine an amount for an incentive award when a said incentive award is determined due a said referring client.

15. A method for providing referral based incentive awards as recited in claim 13 further including the step of providing a customer move geography field in each of the plurality of client referral records to be used by said processor means to determine an amount for an incentive award when a said incentive award is determined due a said referring client.

16. A method for providing referral based incentive awards as recited in claim 13 further including the step of providing a customer move price metadata field to be used by said processor means to determine an amount for an incentive award when a said incentive award is determined due a said referring client.

17. A method for providing referral based incentive awards as recited in claim 13 further including the step of providing a customer commission terms metadata field used by said processor means to determine a payment format for an incentive award when a said incentive award is determined due a said referring client.

18. A method for providing referral based incentive awards as recited in claim 13 further including the step of using said processor means to generate a report for said client referral records based on user selected metadata fields relating to said client records.

19. A computer program product, comprising a computer useable medium having a computer readable program code embodied therein, said computer readable program code adapted to be executed to implement a method for providing referral based incentive awards for a moving company, said method comprising the steps of:
storing a plurality of client referral records in storage means, each of the plurality of client referral records having a plurality of metadata fields identifying a referring clients name, a referred customers name and information relating to a status of the move task associated with the referred customer's name; and
processing each of said client referral records in processor means to determine if an incentive award is due a said referring client based at least upon a change in status of a said move task associated with a said referred customers name.

20. A computer program product as recited in claim 19, wherein said method further includes the steps of:
providing a customer move type metadata field in each of the plurality of client referral records to determine an amount for an incentive award when a said incentive award is determined due a said referring client;
providing a customer move geography field in each of the plurality of client referral records to further determine an amount for an incentive award;
providing a customer move price metadata field in each of the plurality of client referral records to further determine an amount for an incentive award; and
providing a customer commission terms metadata field in each of the plurality of client referral records to determine a payment format for an incentive award.
